(19) United States
(12) Patent Application Publication
(10) Pub. No.: US 2020/0221859 A1
(43) Pub. Date: Jul. 16, 2020

(54) PET TEETH CLEANING ASSEMBLY

(71) Applicant: William Scully, Hyde Park, MA (US)

(72) Inventor: William Scully, Hyde Park, MA (US)

(21) Appl. No.: 16/249,640

(22) Filed: Jan. 16, 2019

(51) Int. Cl. A46B 5/04; A01K 13/00; A41D 19/00; A46B 9/04

(52) U.S. Cl. CPC A46B 5/04; A01K 13/001; A46B 2200/1086; A41D 19/0082; A46B 9/04; A41D 19/0024

(57) ABSTRACT

A pet teeth cleaning assembly includes a glove configured to be positioned on a person's hand. The glove includes five finger sleeves, a hand portion and a wrist sleeve. Each of the finger sleeves has perimeter wall extending upwardly from the hand portion and a distal end with respect to the hand portion. A plurality of bristles is provided. Each of a plurality of the finger sleeves has the bristles integrally coupled thereto. Tooth cleaning material is positionable on the bristles and rubbed against teeth of a dog to clean the teeth.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to tooth cleaning devices and more particularly pertains to a new tooth cleaning device for facilitating the cleaning of the teeth and gums of a pet.

### BRIEF SUMMARY OF THE INVENTION

An embodiment of the disclosure meets the needs presented above by generally comprising a glove configured to be positioned on a person's hand. The glove includes five finger sleeves, a hand portion and a wrist sleeve. Each of the finger sleeves has perimeter wall extending upwardly from the hand portion and a distal end with respect to the hand portion. A plurality of bristles is provided. Each of a plurality of the finger sleeves has the bristles integrally coupled thereto. Tooth cleaning material is positionable on the bristles and rubbed against teeth of a dog to clean the teeth.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a pet teeth cleaning assembly according to an embodiment of the disclosure.

FIG. 2 is a rear view of an embodiment of the disclosure.

FIG. 3 is a left side view of an embodiment of the disclosure.

FIG. 4 is a partial isometric view of a finger sleeve of an embodiment of the disclosure.

### DETAILED DESCRIPTION OF THE INVENTION

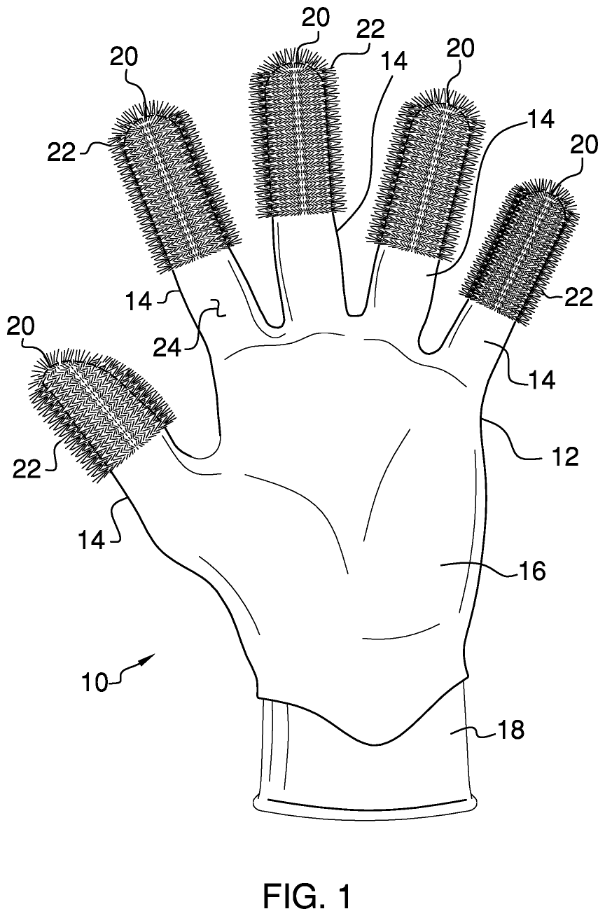

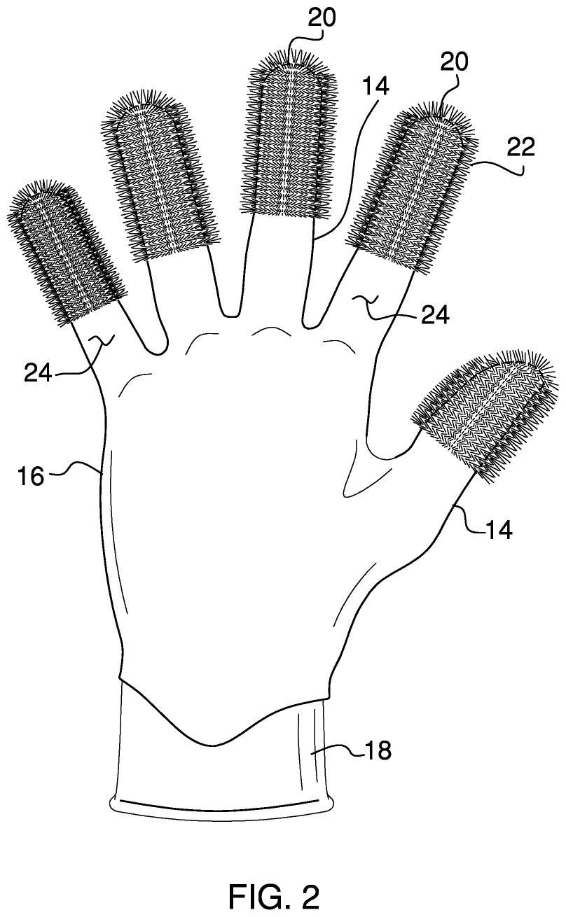

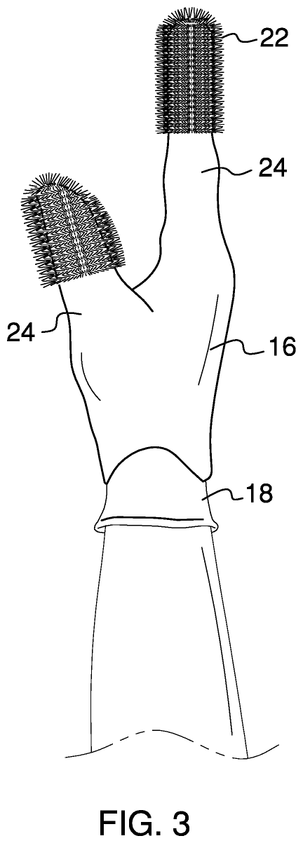

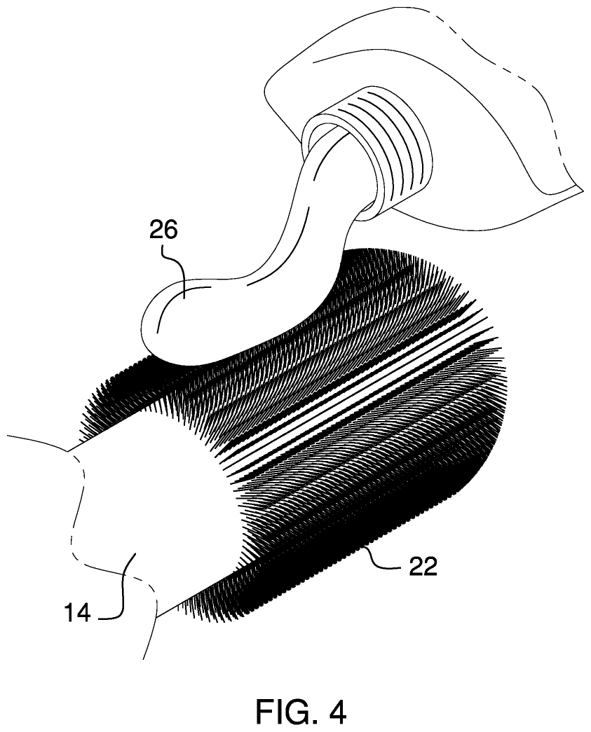

With reference now to the drawings, and in particular to FIGS. 1 through 4 thereof, a new tooth cleaning device embodying the principles and concepts of an embodiment of the disclosure and generally designated by the reference numeral 10 will be described.

As best illustrated in FIGS. 1 through 4, the pet teeth cleaning assembly 10 generally comprises a glove 12 configured to be positioned on a person's hand. The glove 12 includes five finger sleeves 14, a hand portion 16 and a wrist sleeve 18. Each of the finger sleeves 14 has perimeter wall 24 extending upwardly from the hand portion 16 and thereby comprises a generally conventional glove shape. Each of the finger sleeves 14 has a distal end 20 with respect to the hand portion 16. The sleeves 14 are each generally tubular shaped and the distal ends 20 having an outer surface being convexly concave. The glove 12 comprises a water resistant material which may preferably be fluid impermeable. The water resistant material will typically comprise a plastic or an elastomeric material. The glove 12 may be resiliently stretchable to allow for a tight fit on a person's hand and to accommodate hands of differing sizes.

A plurality of bristles 22 is provided. A plurality of the finger sleeves 14, such as least two of the finger sleeves 14, has the bristles 22 integrally coupled thereto. However, the bristles 22 may be positioned on each of the finger sleeves 14 as shown in the Figures. The bristles 22 and the glove 12 may form a unitary structure wherein the bristles 22 are comprised of the same material as the glove 12. The bristles 22 are positioned adjacent to the terminal ends 20 of an associated one of the finger sleeves 14. The bristles 22 are arranged such that the bristles 22 positioned around each the perimeter wall 24 of the associated one of the finger sleeves 14. That is, the bristles 22 are positioned all around the outer surface of each finger sleeve 14 wherein each bristle 22 is orientated substantially perpendicular to the surface to which it is attached. Each of the bristles 22 has a length generally between 0.25 inches and 1.0 inches. The bristles 22 are also positioned on the distal end 20 of the associated one of the finger sleeves 14. Each of the bristles 22 is comprised of a resiliently bendable material.

In use, the user of the assembly 10 places the glove 12 on their hand and then places tooth cleaning material 26, which is safe and approved for animals, is positioned on the bristles 22. The bristles 22 are then rubbed against the teeth and gums of the animal, such as a dog, to clean the teeth. Having multiple finger sleeves 14 with bristles 22 allows the user to quickly clean multiple areas of the dog's mouth to ensure that the process is less time consuming. The glove 12 may then be removed and thrown away or cleaned and used again.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A dog tooth cleaning apparatus to facilitate the cleaning of a dog's teeth, said apparatus comprising:
a glove configured to be positioned on a person's hand, said glove including five finger sleeves, a hand portion and a wrist sleeve, each of said finger sleeves having perimeter wall extending upwardly from said hand portion, each of said finger sleeves having a distal end with respect to said hand portion;
a plurality of bristles being provided, a plurality of said finger sleeves having said bristles integrally coupled thereto; and
wherein tooth cleaning material is positionable on said bristles and rubbed against teeth of a dog to clean the teeth.

2. The dog tooth cleaning apparatus according to claim 1, wherein said glove comprises a water resistant material.

3. The dog tooth cleaning apparatus according to claim 2, wherein said water resistant material comprises a plastic or an elastomeric material.

4. The dog tooth cleaning apparatus according to claim 1, wherein said bristles is positioned adjacent to said terminal ends of an associated one of said finger sleeves.

5. The dog tooth cleaning apparatus according to claim 4, wherein said bristles are arranged such that said bristles positioned around each said perimeter wall of said associated one of said finger sleeves.

6. The dog tooth cleaning apparatus according to claim 5, wherein said bristles are positioned on said distal end of said associated one of said finger sleeves.

7. The dog tooth cleaning apparatus according to claim 6, wherein each of said bristles is comprised of a resiliently bendable material.

8. The dog tooth cleaning apparatus according to claim 1, wherein each of said bristles is comprised of a resiliently bendable material.

9. A dog tooth cleaning apparatus to facilitate the cleaning of a dog's teeth, said apparatus comprising:
a glove configured to be positioned on a person's hand, said glove including five finger sleeves, a hand portion and a wrist sleeve, each of said finger sleeves having perimeter wall extending upwardly from said hand portion, each of said finger sleeves having a distal end with respect to said hand portion, said glove comprising a water resistant material, said water resistant material comprising a plastic or an elastomeric material;
a plurality of bristles being provided, a plurality of said finger sleeves having said bristles integrally coupled thereto, said bristles being positioned adjacent to said terminal ends of an associated one of said finger sleeves, said bristles being arranged such that said bristles positioned around each said perimeter wall of said associated one of said finger sleeves, said bristles being positioned on said distal end of said associated one of said finger sleeves, each of said bristles being comprised of a resiliently bendable material; and
wherein tooth cleaning material is positionable on said bristles and rubbed against teeth of a dog to clean the teeth.
